(19) United States
(12) Patent Application Publication
(10) Pub. No.: US 2024/0051375 A1
(43) Pub. Date: Feb. 15, 2024

(54) WINDSHIELD-PROTECTING FILM

(71) Applicant: CASSANDRA GIBBS-MERCER, St. Augustine, FL (US)

(72) Inventor: CASSANDRA GIBBS-MERCER, St. Augustine, FL (US)

(21) Appl. No.: 17/883,725

(22) Filed: Aug. 9, 2022

(51) Int. Cl. B60J 1/20; B32B 7/12; B32B 17/06; C09J 7/40; C09J 7/20

(52) U.S. Cl. CPC B60J 1/2094; B32B 7/12; B32B 17/06; C09J 7/405; C09J 7/20; B32B 2255/00; B32B 2307/412; B32B 2307/536; B32B 2307/732; B32B 2307/558; C09J 2400/28; C09J 2400/22; C09J 2203/354; C09J 2400/143

(57) ABSTRACT

The windshield-protecting film comprises a glass panel and an adhesive layer. The windshield-protecting film may be a protective guard for a windshield of a vehicle. The glass panel may be coupled to the windshield such that the glass panel covers the outside of the windshield. The glass panel may be made of tempered glass and may prevent debris from damaging the windshield if the debris strikes the windshield. The adhesive layer may adhere the glass panel to the outside of the windshield. As non-limiting examples, the debris may be gravel, stones, dirt, sticks, broken glass, or metal fragments that may be circulated by wind, throw from road surfaces by traffic, fall from overpasses, or fall off of trucks.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of windshield-protecting devices, more specifically, a windshield-protecting film.

### SUMMARY OF INVENTION

The windshield-protecting film comprises a glass panel and an adhesive layer. The windshield-protecting film may be a protective guard for a windshield of a vehicle. The glass panel may be coupled to the windshield such that the glass panel covers the outside of the windshield. The glass panel may be made of tempered glass and may prevent debris from damaging the windshield if the debris strikes the windshield. The adhesive layer may adhere the glass panel to the outside of the windshield. As non-limiting examples, the debris may be gravel, stones, dirt, sticks, broken glass, or metal fragments that may be circulated by wind, throw from road surfaces by traffic, fall from overpasses, or fall off of trucks.

An object of the invention is to couple a glass panel made of tempered glass to the outside of a vehicle's windshield.

Another object of the invention is to protect the windshield from damage due to debris striking the windshield.

A further object of the invention is to provide an adhesive layer to hold the glass panel in place.

Yet another object of the invention is to provide a peel-off backing to cover the adhesive layer prior to installation.

These together with additional objects, features and advantages of the windshield-protecting film will be readily apparent to those of ordinary skill in the art upon reading the following detailed description of the presently preferred, but nonetheless illustrative, embodiments when taken in conjunction with the accompanying drawings.

In this respect, before explaining the current embodiments of the windshield-protecting film in detail, it is to be understood that the windshield-protecting film is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the windshield-protecting film.

It is therefore important that the claims be regarded as including such equivalent construction insofar as they do not depart from the spirit and scope of the windshield-protecting film. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is an isometric view of an embodiment of the disclosure.

FIG. 2 is a rear view of an embodiment of the disclosure.

FIG. 3 is a front in-use view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

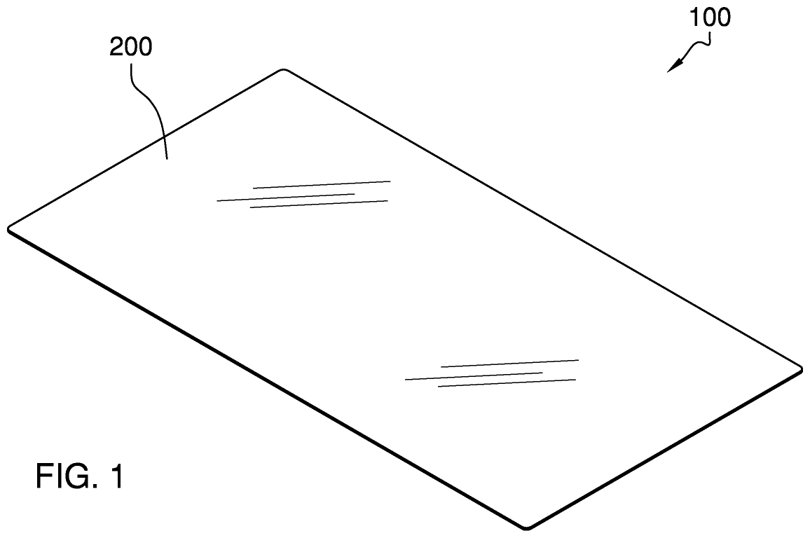

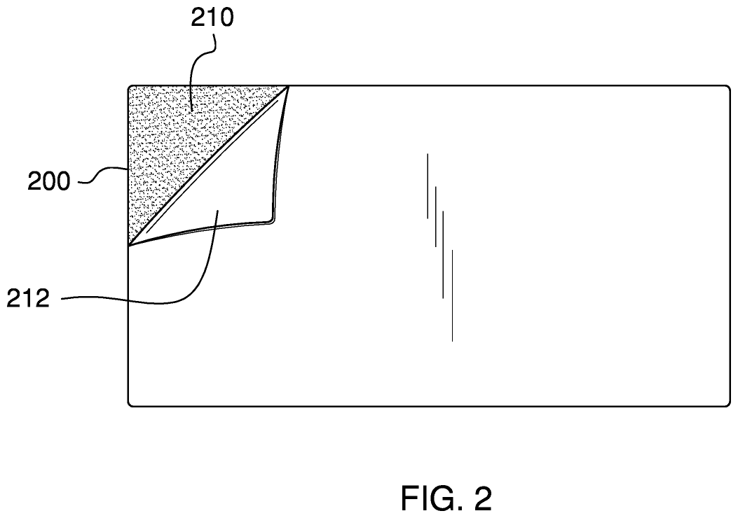

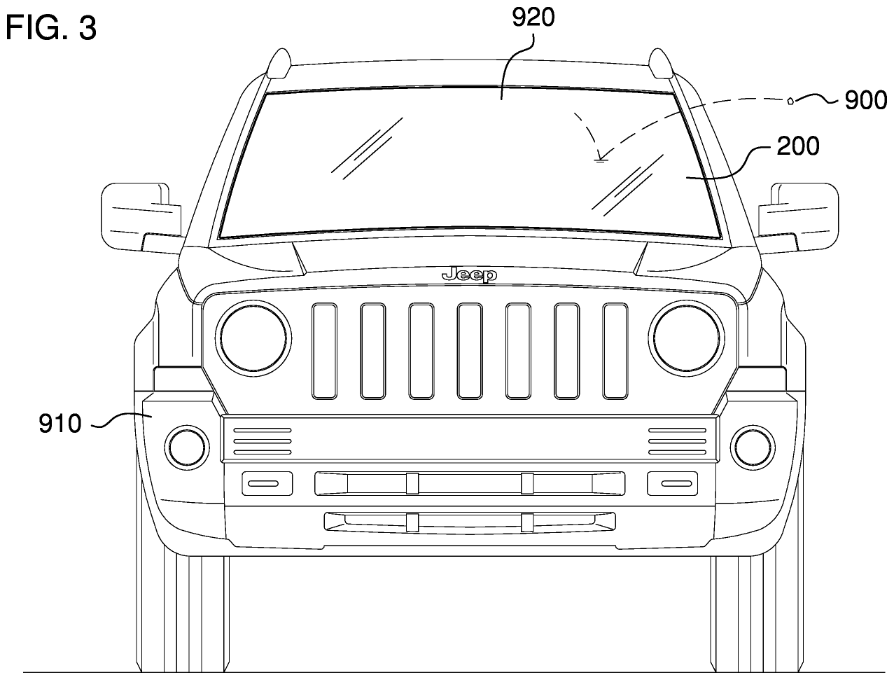

Detailed reference will now be made to a first potential embodiment of the disclosure, which is illustrated in FIGS. 1 through 3.

The windshield-protecting film 100 (hereinafter invention) comprises a glass panel 200 and an adhesive layer 210. The invention 100 may be a protective guard for a windshield 920 of a vehicle 910. The glass panel 200 may be coupled to the windshield 920 such that the glass panel 200 covers the outside of the windshield 920. The glass panel 200 may prevent debris from damaging the windshield 920 if the debris 900 strikes the windshield 920. The adhesive layer 210 may adhere the glass panel 200 to the outside of the windshield 920. As non-limiting examples, the debris 900 may be gravel, stones, dirt, sticks, broken glass, or metal fragments that may be circulated by wind, throw from road surfaces by traffic, fall from overpasses, or fall off of trucks.

The glass panel 200 may be made of tempered glass. The glass panel 200 may fit the windshield 920 of a designated vehicle based upon year, make and model of the vehicle 910. The glass panel 200 may generally be described as rectangular. However, the specific shape of the glass panel 200 may be selected to match the shape of the designated vehicle. The dimensions of the glass panel 200 may be selected to match the shape of the windshield 920 of the designated vehicle. The glass panel 200 may be shaped to match the 3D contours of the windshield 920 of the designated vehicle if the windshield 920 of the designated vehicle is non-planar.

The glass panel 200 may have a hardness that measures at least 590 on the Vickers hardness scale. The glass panel 200 may be clear.

The glass panel 200 may have a thickness of between 1/16 inch and 5/16 inch. In a preferred embodiment, the glass panel 200 may be made available in a choice of thicknesses such that the thickness of the glass panel 200 may be selected from ⅛ inch thick, 5/32 inch thick, 3/16 inch thick, and ¼ inch thick.

The adhesive layer 210 may be a substance spread over the inside surface of the glass panel 200 that binds the glass panel 200 to the windshield 920 and resists separation of the glass panel 200 and the windshield 920. The adhesive layer 210 may be pre-applied to the glass panel 200 and covered by a peel-off backing 212 to prevent contamination of the adhesive layer 210 prior to installation. The peel-off backing 212 may be removed from the glass panel 200 during installation to reveal the adhesive layer 210. The peel-off backing 212 may be a layer of material that adheres to the adhesive layer 210 and may be removable from the adhesive layer 210. As non-limiting examples, the peel-off backing 212 may be a sheet of paper or plastic film. The glass panel 200 may be coupled to the windshield 920 by placing the adhesive layer 210 side of the glass panel 200 against the windshield 920 and by pressing the glass panel 200 against the windshield 920.

In some embodiments, the glass panel 200 may be removed from the windshield 920 by prying the glass panel 200 off, by applying one or more solvents to dissolve the adhesive layer 210, by applying heat to the adhesive layer 210, by applying cold to the adhesive layer 210, or any combination thereof.

The invention 100 may deflect the debris 900 that strikes the glass panel 200 such that neither the glass panel 200 nor the windshield 920 is damaged. If the debris 900 strikes with force that breaks the glass panel 200, the glass panel 200 may be removed and replaced at a lower cost than the cost of replacing the windshield 920.

In use, the glass panel 200 may be applied to the windshield 920 by cleaning and drying the windshield 920, by removing the peel-off backing 212 that covers the adhesive layer 210, by placing the glass panel 200 over the windshield 920 with the adhesive layer 210 between the glass panel 200 and the windshield 920, and by pressing the glass panel 200 against the windshield 920.

### Definitions

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” may refer to top and “lower” may refer to the bottom. As a non-limiting example, the upper end of a vertical shaft is the top end of the vertical shaft.

As used herein, the words “couple”, “couples”, “coupled” or “coupling”, may refer to connecting, either directly or indirectly, and does not necessarily imply a mechanical connection.

As used herein, the word “debris” may include any form of hazardous or potential hazardous material or object produced by vehicular or non-vehicular sources which is located on or near the travel surface of a road and which is foreign to a normal road surface.

As used in this disclosure, “transparent” may refer to a material that allows light to pass through the material without significant scattering such that an object can be seen without distortion through the material. “Clear” may be considered to be both transparent and colorless.

As used herein, “vehicle” may refer to a device that is used for transporting passengers, goods, equipment, or combinations thereof.

As used herein, “Vickers hardness” may refer to a measurement of a material's hardness obtained by applying the Vickers hardness test. The test may be applied to metals, glass, and other materials. The test may observe the material's ability to resist plastic deformation from a standard source of pressure and may be performed by pressing a pyramidal diamond tip into a material and measuring the indentation created by the diamond tip. The unit of hardness reported may be known as the Vickers Pyramid Number (HV) or Diamond Pyramid Hardness (DPH).

As used in this disclosure, a “windshield” may refer to the front window of a vehicle that is intended to shield the occupants of the vehicle from the wind generated by the normal forward motion of the vehicle.

With respect to the above description, it is to be realized that the optimum dimensional relationship for the various components of the invention described above and in FIGS. 1 through 3, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A windshield-protecting film comprising:
a glass panel and an adhesive layer;
wherein the windshield-protecting film is a protective guard for a windshield of a vehicle;
wherein the glass panel is coupled to the windshield such that the glass panel covers the outside of the windshield;
wherein the glass panel prevents debris from damaging the windshield if the debris strikes the windshield;
wherein the adhesive layer adheres the glass panel to the outside of the windshield.

2. The windshield-protecting film according to claim 1
wherein the glass panel is made of tempered glass.

3. The windshield-protecting film according to claim 2
wherein the glass panel fits the windshield of a designated vehicle based upon year, make and model of the vehicle.

4. The windshield-protecting film according to claim 3
wherein the specific shape of the glass panel is selected to match the shape of the designated vehicle.

5. The windshield-protecting film according to claim 4
wherein the dimensions of the glass panel are selected to match the shape of the windshield of the designated vehicle.

6. The windshield-protecting film according to claim 5
wherein the glass panel is shaped to match the 3D contours of the windshield of the designated vehicle.

7. The windshield-protecting film according to claim 6
wherein the glass panel has a hardness that measures at least 590 on the Vickers hardness scale.

8. The windshield-protecting film according to claim 7
wherein the glass panel is clear.

9. The windshield-protecting film according to claim 8
wherein the glass panel has a thickness of between 1/16 inch and 5/16 inch.

10. The windshield-protecting film according to claim 9
wherein the glass panel is made available in a choice of thicknesses such that the thickness of the glass panel is selected from ⅛ inch thick, 5/32 inch thick, 3/16 inch thick, and ¼ inch thick.

11. The windshield-protecting film according to claim 9
wherein the adhesive layer is a substance spread over the inside surface of the glass panel that binds the glass panel to the windshield and resists separation of the glass panel and the windshield.

12. The windshield-protecting film according to claim 11
wherein the adhesive layer is pre-applied to the glass panel and covered by a peel-off backing to prevent contamination of the adhesive layer prior to installation.

13. The windshield-protecting film according to claim 12
wherein the peel-off backing is removed from the glass panel during installation to reveal the adhesive layer.

14. The windshield-protecting film according to claim 13
wherein the peel-off backing is a layer of material that adheres to the adhesive layer and is removable from the adhesive layer.

15. The windshield-protecting film according to claim 14
wherein the peel-off backing is a sheet of paper or plastic film.

16. The windshield-protecting film according to claim 15
wherein the glass panel is coupled to the windshield by placing the adhesive layer side of the glass panel against the windshield and by pressing the glass panel against the windshield.

17. The windshield-protecting film according to claim 16
wherein the glass panel is removed from the windshield by prying the glass panel off, by applying one or more solvents to dissolve the adhesive layer, by applying heat to the adhesive layer, by applying cold to the adhesive layer, or any combination thereof.

18. The windshield-protecting film according to claim 17
wherein the windshield-protecting film deflects the debris that strikes the glass panel such that neither the glass panel nor the windshield is damaged.

19. The windshield-protecting film according to claim 17
wherein if the debris strikes with force that breaks the glass panel, the glass panel is removed and replaced at a lower cost than the cost of replacing the windshield.
